(19) United States
(12) Patent Application Publication
(10) Pub. No.: US 2021/0369562 A1
(43) Pub. Date: Dec. 2, 2021

(54) HEADGEAR WITH STIMULATION ELEMENTS AND RELATED METHOD

(71) Applicant: Cap On ApS, Silkeborg (DK)

(72) Inventor: Lise Moeslund BENDER, Silkeborg (DK)

(73) Assignee: Cap On ApS, Silkeborg (DK)

(21) Appl. No.: 17/257,316

(22) PCT Filed: Jul. 2, 2019
(86) PCT No.: PCT/EP2019/067707

§ 371 Date: Dec. 31, 2020

(30) Foreign Application Priority Data
Jul. 3, 2018 (DK) PA2018 00354

(51) Int. Cl. A61H 39/04

(52) U.S. Cl. CPC A61H 39/04; A61H 2201/1604; A61H 2201/165; A61H 2205/021

(57) ABSTRACT

A headgear, headgear system and related method is disclosed, the headgear comprising a crown with an inner surface; a first stimulation element in a first position on and protruding from the inner surface of the crown, the first position being a center position of the crown; and a second stimulation element in a second position on and protruding from the inner surface of the crown, wherein the second stimulation element comprises a stimulation part and a locking part configured for locking engagement, and wherein a distance between the first stimulation element and the second stimulation element is in the range from 15 mm to about 40 mm.

The present disclosure relates to headgear, such as a cap or a hat, and related method, and in particular to headgear for stimulating selected stimulation zones or points on the scalp of a user.

### BACKGROUND

Acupressure and the alleged benefits thereof have been known for many years, however challenges are experienced in enabling users to perform effective acupressure without the assistance of a professional and over longer periods of time.

### SUMMARY

Accordingly, there is a need for tools and methods for making it easier and more effective for users to perform acupressure without the involvement of a professional.

Accordingly, a headgear is disclosed, the headgear comprising a crown with an inner surface; a first stimulation element in a first position on and protruding from the inner surface of the crown, the first position optionally being a center position of the crown; and a second stimulation element in a second position on and protruding from the inner surface of the crown. The second stimulation element optionally comprises a stimulation part and a locking part configured for locking engagement, and a distance between the first stimulation element and the second stimulation element may be in the range from 15 mm to about 40 mm.

Further, a headgear system is disclosed, the headgear system comprising a headgear comprising a crown with an inner surface, the headgear system comprising a plurality of stimulation elements configured for mounting on the inner surface of the crown.

Also, a method for manufacturing a headgear is disclosed, the method comprising providing a crown of a headgear, the crown having an inner surface; mounting a first stimulation element in a first position on and protruding from the inner surface of the crown, the first position optionally being a center position of the crown; and mounting a second stimulation element in a second position on and protruding from the inner surface of the crown. The second stimulation element optionally comprises a stimulation part and a locking part configured for locking engagement, and a distance between the first stimulation element and the second stimulation element may be in the range from 15 mm to about 40 mm.

The present disclosure allows for stimulation of selected stimulation zones or points on the scalp of a user. Further, self-stimulation of a user's scalp is enabled and facilitated. Further, the present disclosure allows for a personalized headgear adapted to a specific user.

It is an important advantage that the headgear facilitates stimulation of multiple stimulation points of the scalp at the same time while ensuring desired spatial distribution of the stimulated points of the scalp of the user.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 schematically illustrates an exemplary headgear according to the present disclosure,

FIG. 2 is a view of the inner surface of a crown of a headgear,

FIG. 3 is a exploded side view of an exemplary stimulation element,

FIG. 4 is a cross-section of section A of the stimulation element of FIG. 3,

FIG. 5 is a flow diagram of an exemplary method according to the disclosure,

FIG. 6 is a side view of an exemplary stimulation part, and

FIG. 7 is a side view of an exemplary stimulation part.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The present disclosure relates to a headgear. The headgear may be a cap or a hat. The headgear comprises a crown. The crown has an inner surface. The inner surface of the crown faces the scalp of a user when the headgear is worn. The headgear may comprise a brim.

The headgear/headgear system comprises one or more stimulation elements, such as a plurality of stimulation elements. A stimulation element, or at least a stimulation part thereof, is arranged or configured to be arranged in a position on and protruding from the inner surface of the crown. A stimulation element may comprise a stimulation part and optionally a locking part. Accordingly, a stimulation element may comprise two parts configured for locking engagement.

The headgear/headgear system comprises a first stimulation element arranged or configured to be arranged in a first position on and protruding from the inner surface of the crown. The first position of the first stimulation element may be a center position of the crown.

The headgear/headgear system comprises a second stimulation element arranged or configured to be arranged in a second position on and protruding from the inner surface of the crown.

In one or more exemplary headgears, a distance, such as a center-to-center distance e.g.

measured along the inner surface of the crown, between the first stimulation element and the second stimulation element is larger than 5 mm, such as in the range from 5 mm to 70 mm. The distance between the first stimulation element and the second stimulation element, also denoted D_1_2, may be in the range from 15 mm to about 40 mm. The distance between the first stimulation element and the second stimulation element, also denoted D_1_2, may be in the range from 5 mm to about 30 mm.

The first stimulation element and the second stimulation element are optionally arranged along a first guide axis. The first guide axis may extend in a first direction. The first direction may be a forward direction. A forward direction is parallel to the sagittal plane of the user when the headgear is worn in its intended position. A forward direction may form an angle less than 45 degrees, e.g. less than 15 degrees, with the ventral direction of the user when the headgear is worn in its intended position.

The headgear/headgear system may comprise a third stimulation element arranged or configured to be arranged in a third position on and protruding from the inner surface of the crown. The third stimulation element may be arranged along the first guide axis.

In one or more exemplary headgears, a distance, such as a center-to-center distance e.g. measured along the inner surface of the crown, between the first stimulation element and the third stimulation element is larger than 5 mm, such as in the range from 5 mm to 70 mm. The distance between the first stimulation element and the second stimulation element, also denoted D_1_3, may be in the range from 15 mm to about 40 mm.

The headgear/headgear system may comprise a fourth stimulation element arranged or configured to be arranged in a fourth position on and protruding from the inner surface of the crown.

In one or more exemplary headgear/headgear systems, the first stimulation element and the fourth stimulation element are arranged along a second guide axis. The second guide axis may extend in a second direction. The second direction may be a side direction. A side direction is parallel to the coronal plane of the user when the headgear is worn in its intended position. A forward direction may form an angle less than 45 degrees, e.g. less than 15 degrees, with a lateral direction of the user when the headgear is worn in its intended position. The first guide axis and the second guide axis may form an angle larger than 30 degrees, e.g. in the range from 60 degrees to 120 degrees.

In one or more exemplary headgears, a distance, such as a center-to-center distance e.g. measured along the inner surface of the crown, between the first stimulation element and the fourth stimulation element is larger than 5 mm, such as in the range from 5 mm to 70 mm. The distance between the first stimulation element and the fourth stimulation element, also denoted D_1_4, may be in the range from 15 mm to about 40 mm.

The headgear/headgear system may comprise a fifth stimulation element arranged or configured to be arranged in a fifth position on and protruding from the inner surface of the crown. The fifth stimulation element may be arranged along the second guide axis.

In one or more exemplary headgears, a distance, such as a center-to-center distance e.g.

measured along the inner surface of the crown, between the first stimulation element and the fifth stimulation element is larger than 5 mm, such as in the range from 5 mm to 70 mm. The distance between the first stimulation element and the fifth stimulation element, also denoted D_1_5, may be in the range from 15 mm to about 40 mm.

A stimulation element extends along a center axis from a first end to a second end pointing away from the inner surface, i.e. the second end of the stimulation element is configured for contacting and/or facing the scalp of the user when the headgear is worn in its intended position. A stimulation element has an inner height. The inner height of a stimulation element is the distance from the second end to the inner surface of the crown (or to the contact surface of a stimulation part of the stimulation element as described below) measured along the center axis. A stimulation element has a width at the inner surface (maximum extension perpendicular to the center axis). The width at the inner surface may be larger than 4 mm.

A stimulation element, such as the first stimulation element, the second stimulation element, the third stimulation element, the fourth stimulation element, and/or the fifth stimulation element, may have an inner height larger than 2 mm, such as about 4 mm.

The inner height of the first stimulation element, also denoted H_i_1, may be in the range from 2 mm to 6 mm, such as about 4 mm. The inner height of the second stimulation element, also denoted H_i_2, may be in the range from 2 mm to 6 mm, such as about 4 mm. The inner height of the third stimulation element, also denoted H_i_3, may be in the range from 2 mm to 6 mm, such as about 4 mm. The inner height of the fourth stimulation element, also denoted H_i_4, may be in the range from 2 mm to 6 mm, such as about 4 mm. The inner height of the fifth stimulation element, also denoted H_i_5, may be in the range from 2 mm to 6 mm, such as about 4 mm.

A stimulation element, such as the first stimulation element and/or the second stimulation element, may comprise a stimulation part and optionally a locking part. The third stimulation element and/or the fourth stimulation element may comprise a stimulation part and optionally a locking part. The fifth stimulation element may comprise a stimulation part and optionally a locking part. The stimulation part has a stimulation surface and a contact surface and may comprise a first portion comprising a first spherical segment. The first spherical segment has a first radius and a first base. The first base may form a contact surface for facing and contacting the inner surface of the crown when the stimulation element is mounted on the crown. The first base/contact surface may have a diameter (largest extension) in the range from 5 to 20 mm, such as about 10 mm. The stimulation part may comprise a second portion comprising a second spherical segment. The second spherical segment has a second radius and may form the second end of the stimulation element.

The first portion may have a first height (extension along the center axis) in the range from 1 mm to 6 mm, such as about 3.5 mm. The second portion may have a second height (extension along the center axis) in the range from 0.1 mm to 1 mm, such as about 0.3 mm. The second portion forming a protrusion may provide improved stimulation of the scalp.

The stimulation part may comprise an intermediate portion, e.g. forming a smooth transition between the first portion and the second portion. The first radius may be larger than the second radius. In other words, the stimulation part may comprise a generally spherical part (first part), optionally having a protrusion (second portion) at the second end of the stimulation element, the protrusion (second portion) forming a pointy second end. The contact surface of the stimulation part may be circular, optionally with a diameter in the range from 5 to 20 mm. Other shapes, such as oval, polygonal or even starshaped, of the contact surface of the stimulation part is contemplated.

The locking part of the stimulation element may comprise an engagement portion and an outer portion. The engagement portion optionally comprises a rod extending along the center axis and having a bulged outer surface with a tapered end. A tapered end of the rod facilitates penetration of the crown material at mounting of the stimulation element.

The outer portion of the locking part may comprise a contact surface for facing and contacting the outer surface of the crown when the stimulation element is mounted on the crown.

The stimulation part of the first stimulation element may comprise a first portion comprising a first spherical segment. The first spherical segment has a first radius and a first base, the first base forming a contact surface for facing and contacting the inner surface of the crown when the first stimulation element is mounted on the crown, and wherein the contact surface optionally has a diameter in the range from 5 to 20 mm. The stimulation part of the first stimulation element may comprise a second portion comprising a second spherical segment.

The first stimulation element may extend along a center axis, wherein the locking part of the first stimulation element comprises an engagement portion and an outer portion. The the outer portion of the locking part may comprise a contact surface for facing and contacting the outer surface of the crown when the first stimulation element is mounted on the crown.

The second stimulation element extends along a center axis, wherein the locking part of the second stimulation element optionally comprises an engagement portion and an outer portion. The engagement portion of the locking part of the second stimulation element may comprise a rod extending along the center axis and optionally having a bulged outer surface with a tapered end. The outer portion of the locking part of the second stimulation element optionally comprises a contact surface for facing and contacting the outer surface of the crown when the second stimulation element is mounted on the crown.

In one or more exemplary headgear/headgear systems, the stimulation part of stimulation elements are half spheres with a radius in the range from 2 to 6 mm.

The first stimulation element may have a width at the inner surface, also denoted W_1, in the range from 4 to 20 mm. In one or more exemplary headgear/headgear systems, the width W_1 is in the range from 8 mm to 12 mm, e.g. to facilitate a stable mounting of the first stimulation element while allowing a suitable distance between neighbouring stimulation elements on the inner surface of the crown.

The second stimulation element may have a width at the inner surface, also denoted W_2, in the range from 4 to 20 mm. In one or more exemplary headgear/headgear systems, the width W_2 is in the range from 8 mm to 12 mm, e.g. to facilitate a stable mounting of the second stimulation element while allowing a suitable distance between neighbouring stimulation elements on the inner surface of the crown.

The third stimulation element may have a width at the inner surface, also denoted W_3, in the range from 4 to 20 mm. In one or more exemplary headgear/headgear systems, the width W_3 is in the range from 8 mm to 12 mm, e.g. to facilitate a stable mounting of the third stimulation element while allowing a suitable distance between neighbouring stimulation elements on the inner surface of the crown.

The fourth stimulation element may have a width at the inner surface, also denoted W_4, in the range from 4 to 20 mm. In one or more exemplary headgear/headgear systems, the width W_4 is in the range from 8 mm to 12 mm, e.g. to facilitate a stable mounting of the fourth stimulation element while allowing a suitable distance between neighbouring stimulation elements on the inner surface of the crown.

The fifth stimulation element may have a width at the inner surface, also denoted W_5, in the range from 4 to 20 mm. In one or more exemplary headgear/headgear systems, the width W_5 is in the range from 8 mm to 12 mm, e.g. to facilitate a stable mounting of the fifth stimulation element while allowing a suitable distance between neighbouring stimulation elements on the inner surface of the crown.

In one or more exemplary headgear/headgear systems, the first stimulation element is different from the second stimulation element, e.g. W_1 is different from, e.g. larger than or smaller than W_2, and/or H_i_1 is different from, e.g. larger than or smaller than, H_i_2. Different stimulation elements may advantageously facilitate different degrees of stimulation of stimulation points which may be desirable, e.g. when the stimulation points have different properties, e.g. skin thickness and/or sensibility.

In one or more exemplary headgear/headgear systems, the inner height of the stimulation element(s) is less than half the width at the inner surface. In one or more exemplary headgear/headgear systems, H_i_1<0.5W_1, e.g. H_i_1<0.45W_1. In one or more exemplary headgear/headgear systems, H_i_2<0.5W_2, e.g. H_i_2<0.45W_2. In one or more exemplary headgear/headgear systems, H_i_3<0.5W_3, e.g. H_i_3<0.45W_3. In one or more exemplary headgear/headgear systems, H_i_4<0.5W_4, e.g. H_i_4<0.45W_4. In one or more exemplary headgear/headgear systems, H_i_5<0.5W_5, e.g. H_i_5<0.45W_5. Thereby, stimulation elements, which are tailored to acupressure of the scalp (and the relatively thin skin on top of the head) are provided.

The stimulation elements may have the same size and/or shape, thus simplifying assembly and/or reducing production costs.

The headgear may comprise a first guide line and/or a second guide line on the inner surface of the crown. The first guide line is optionally indicative of a position of the first stimulation element (first position), the second stimulation element (second position), and the third stimulation element (third position). The second guide line is optionally indicative of a position of the first stimulation element (first position), the fourth stimulation element (fourth position), and the fifth stimulation element (fifth position). One or more guide lines facilitates correct mounting of stimulation elements on the inner surface of the crown. The first guide line may be parallel or substantially parallel (±10 degrees) to the first direction.

The second guide line may be parallel or substantially parallel (±10 degrees) to the second direction. The headgear may comprise a left marker and/or a right marker on the crown. The left marker is optionally arranged on the left side of the crown when the headgear is worn in its intended position and assists the user in positioning the headgear in the correct/optimum position for acupressure of the scalp. The right marker is optionally arranged on the right side of the crown when the headgear is worn in its intended position and assists the user in positioning the headgear in the correct/optimum position for acupressure of the scalp. The left marker may be different from the right marker. Marker(s) may be particular advantageous when the headgear is a hat.

The present disclosure also relates to use of a headgear/headgear system as disclosed herein for acupressure on the scalp of a user, such as a child.

Also disclosed is a method for manufacturing a headgear, the method comprising: providing a crown of a headgear, the crown having an inner surface; mounting a first stimulation element in a first position on and protruding from the inner surface of the crown; and mounting a second stimulation element in a second position on and protruding from the inner surface of the crown. The method may comprise mounting a third stimulation element in a third position on and protruding from the inner surface of the crown. The method may comprise mounting a fourth stimulation element in a fourth position on and protruding from the inner surface of the crown. The method may comprise mounting a fifth stimulation element in a fifth position on and protruding from the inner surface of the crown.

The method may comprise obtaining a first distance, e.g. including obtaining a finger width of a user, and wherein mounting the second stimulation element in a second position on and protruding from the inner surface of the crown comprises mounting the second stimulation element at a distance D_1_2 from the first stimulation element, wherein the distance D_1_2 corresponds to the first distance. The first distance may be indicative of a finger width of a user, such as the width of two or three fingers of the intended user of the headgear.

In the method, mounting the third stimulation element in a third position on and protruding from the inner surface of the crown comprises mounting the third stimulation element at a distance D_1_3 from the first stimulation element, wherein the distance D_1_3 corresponds to the first distance.

In the method, mounting the fourth stimulation element in a fourth position on and protruding from the inner surface of the crown comprises mounting the fourth stimulation element at a distance D_1_4 from the first stimulation element, wherein the distance D_1_4 corresponds to the first distance.

In the method, mounting the fifth stimulation element in a fifth position on and protruding from the inner surface of the crown comprises mounting the fifth stimulation element at a distance D_1_5 from the first stimulation element, wherein the distance D_1_5 corresponds to the first distance.

The crown may be formed of an elastic material, such as an elastic fabric. Thereby, the crown may contribute to the acupressure effect by pressing the stimulation elements towards the scalp of the user.

Also disclosed is an acupressure tool comprising a carrier device, such as a crown of a headgear or a wristband, and one or more stimulation elements, such as a plurality of stimulation elements, as disclosed herein.

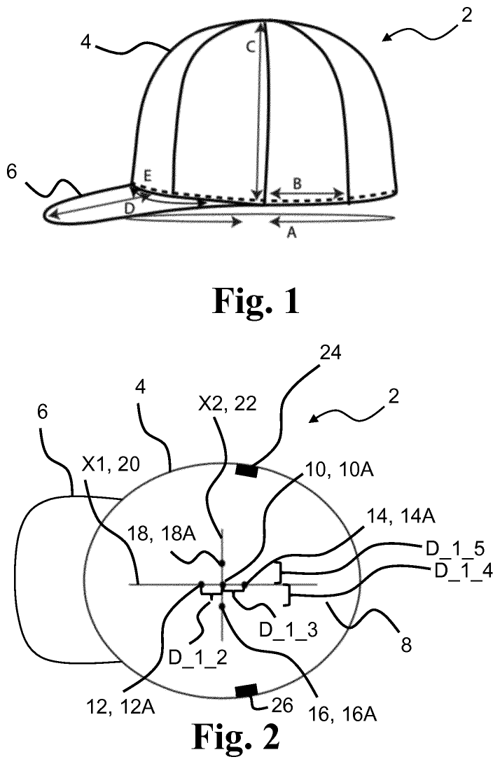

FIG. 1 shows an exemplary headgear 2 embodied as a cap, the headgear 2 comprising a crown 4 with an inner surface and a number of stimulation elements mounted on the inner surface of the crown. The headgear 2 optionally comprises a brim 6. The brim 6 may be indicative of a desired position in which the headgear is to be worn, i.e. the brim 6 may operate as a wear direction indicator. The headgear 2 may be manufactured according to the method disclosed herein, e.g. method 100.

FIG. 2 shows a schematic view of the inner surface 8 of crown 4 of headgear 2. The headgear 2 comprises a first stimulation element 10 in a first position 10A on and protruding from the inner surface 8 of the crown 4; and a second stimulation element 12 in a second position 12A on and protruding from the inner surface 8 of the crown 4. Optionally, the headgear 2 comprises a third stimulation element 14 in a third position 14A on and protruding from the inner surface 8 of the crown 4; a fourth stimulation element 16 in a fourth position 16A on and protruding from the inner surface 8 of the crown 4; and a fifth stimulation element 18 in a fifth position 18A on and protruding from the inner surface 8 of the crown 4.

Stimulation elements 10, 12, 14 are arranged along first guide axis X1 (parallel to forward direction), and stimulation elements 10, 16, 18 are arranged along second guide axis X2 (parallel to side direction). The second guide axis X2 is perpendicular to the first guide axis X1. The headgear 2 optionally comprises a first guide line 20 and/or a second guide line 22 on the inner surface 8. One or more guide lines 20, 22 facilitate correct mounting of stimulation elements 10, 12, 14, 16, 18 on the inner surface of the crown. The first guide line may be parallel or substantially parallel (±10 degrees) to the first direction. The second guide line may be parallel or substantially parallel (±10 degrees) to the second direction.

The distance D12 between the first stimulation element 10 and the second stimulation element 12 is larger than 5 mm, such as about 25 mm as illustrated. The distance D_1_3 between the first stimulation element 10 and the third stimulation element 14 is larger than 5 mm, such as about 25 mm as illustrated. The distance D_1_4 between the first stimulation element 10 and the fourth stimulation element 16 is larger than 5 mm, such as about 25 mm as illustrated. The distance D15 between the first stimulation element 10 and the fifth stimulation element 18 is larger than 5 mm, such as about 25 mm as illustrated.

The headgear 2 optionally comprises a left marker 24 arranged on the inner surface 8 of the crown at or near the edge of the crown on the left side of the crown, when the headgear is worn in its intended position. The headgear 2 optionally comprises a right marker 26 arranged on the inner surface 8 of the crown at or near the edge of the crown on the right side of the crown, when the headgear is worn in its intended position. The left marker 24 and/or the right marker 26 assist the user in positioning the headgear in the correct/optimum position for acupressure of the scalp. The left marker 24 is optionally different from the right marker 26, for example the left marker 24 may comprise the letter “L” and/or the right marker 26 may comprise the letter “R”. The left marker 24 may have a first color, e.g. red, and/or the right marker 26 may have a second color, e.g. green.

FIG. 3 shows an exploded side view of an exemplary stimulation element, such as stimulation element 10, 12, 14, 16, 18. The stimulation element is a two-part element comprising a stimulation part 30 and a locking part 32. The stimulation element 10, 12, 14, 16, 18 extends along a center axis XC from a first end 34 to a second end 36 pointing away from the inner surface of the crown when mounted in the crown. Thus, the second end 36 of the stimulation element is configured for contacting and/or facing the scalp/hair of the user when the headgear 2 is worn in its intended position. A stimulation element has an inner height 38 being the distance from the second end to the inner surface of the crown measured along the center axis. The inner height 38 of exemplary stimulation elements 10, 12, 14, 16, 18 is about 4 mm. The stimulation elements 10, 12, 14, 16, 18 each has a width 40 at the inner surface 8 of the crown (maximum extension perpendicular to the center axis). The width 40 of exemplary stimulation elements 10, 12, 14, 16, 18 is about 10 mm.

The stimulation element 10, 12, 14, 16, 18 comprises a stimulation part 30 and a locking part 32. The stimulation part 30 has a stimulation surface 42 and a (planar) contact surface 43. The stimulation part 30 comprises a first portion 44 comprising a first spherical segment 46 with a first radius and a first base 48 forming the contact surface 43 for facing and contacting the inner surface of the crown when the stimulation element is mounted on the crown. The stimulation part 30 optionally comprises a second portion 50 comprising a second spherical segment 52 with a second radius and forming the second end 36 of the stimulation element. Optionally, the stimulation part 30 comprises an intermediate portion 53 forming a smooth transition between the first portion 44 and the second portion 50. The first radius of the first spherical segment 46 is larger than the second radius of the second spherical segment forming a pointy second end 36. In other words, the stimulation part 30 may comprise a generally spherical part (first part 44), optionally having a protrusion (second part 50) at the second end of the stimulation element, the protrusion (second part) forming a pointy second end. The contact surface of the stimulation part is circular with a diameter of 10 mm.

The first portion has a first height (extension along center axis) of about 3.6 mm and the second portion has a second height (extension along center axis) of about 0.1 mm.

The locking part 32 comprises an engagement portion 54 and an outer portion 50. The engagement portion 54 comprises a rod 58 extending along the center axis and having a bulged outer surface with a tapered end 60 facilitating penetration of the crown material at mounting of the stimulation element. The outer portion 60 of the locking part 32 comprises a contact surface 62 for facing and contacting the outer surface of the crown when the stimulation element is mounted on the crown.

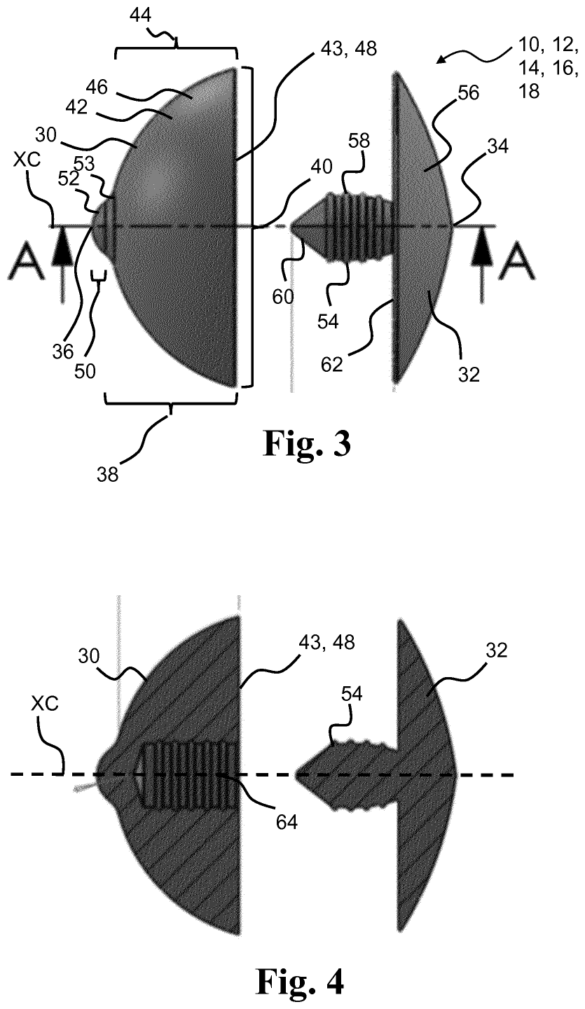

FIG. 4 is a cross-section of section A of the stimulation element as shown and indicated in FIG. 3. The stimulation part 30 comprises an engagement portion 64 formed as a bore in the contact surface 43 and extending along the center axis XC. At mounting, the locking part 32 is pressed through the crown material and press-fitted (locked) with the stimulation part 30 by the respective engagement portions 54, 64 engaging in a press-fit coupling.

The surface of the engagement portion 64 may be bulged. It is to be noted that other locking mechanisms, such as a threading, may be employed. Alternatively, the stimulation elements may be attached to the inner surface by gluing, welding or sewing.

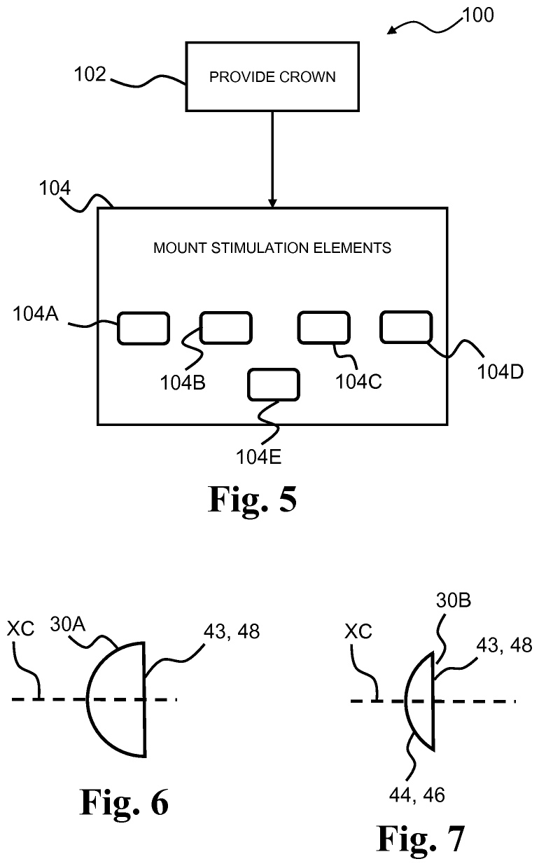

FIG. 5 is a flow diagram of an exemplary method of for manufacturing a headgear. The method 100 comprises providing 102 a crown of a headgear, the crown having an inner surface; and mounting 104 stimulation elements. Mounting 104 stimulation elements comprises mounting 104A a first stimulation element, such as a stimulation element as disclosed herein, in a first position on and protruding from the inner surface of the crown; and mounting 104B a second stimulation element, such as a stimulation element as disclosed herein, in a second position on and protruding from the inner surface of the crown. The method 100 optionally comprises mounting 104C a third stimulation element, such as a stimulation element as disclosed herein, in a third position on and protruding from the inner surface of the crown; and/or optionally mounting 104D a fourth stimulation element, such as a stimulation element as disclosed herein, in a fourth position on and protruding from the inner surface of the crown. The method 100 may comprise mounting 104E a fifth stimulation element, such as a stimulation element as disclosed herein, in a fifth position on and protruding from the inner surface of the crown.

FIG. 6 shows a side view of an exemplary stimulation part of a stimulation element comprising locking element 32, such as one or more of stimulation elements 10, 12, 14, 16, 18. The stimulation part 30A is a semi-sphere with a radius of 5 mm, i.e. the stimulation part 30A has a circular contact surface 43 with a diameter of 10 mm. Engagement portion (not shown) is formed in the contact surface 43.

FIG. 7 shows a side view of an exemplary stimulation part of a stimulation element comprising locking element 32, such as one or more of stimulation elements 10, 12, 14, 16, 18. The stimulation part 30B is formed by a first portion 44 comprising a first spherical segment 46 with a first radius and a first base 48 forming the contact surface 43 for facing and contacting the inner surface of the crown when the stimulation element is mounted on the crown. The first height (extension along center axis XC) of the first portion 44 is about 3 mm and the diameter of the contact surface is about 10 mm. Engagement portion (not shown) is formed in the contact surface 43.

Also disclosed is headgear and method for manufacturing a headgear according to any of the following items.

Item 1. A headgear comprising:
a crown with an inner surface;
a first stimulation element in a first position on and protruding from the inner surface of the crown; and
a second stimulation element in a second position on and protruding from the inner surface of the crown.

Item 2. Headgear according to item 1, wherein a distance between the first stimulation element and the second stimulation element is in the range from 5 mm to 30 mm.

Item 3. Headgear according to any of items 1-2, the headgear comprising a third stimulation element in a third position on and protruding from the inner surface of the crown, wherein the first stimulation element, the second stimulation element, and the third stimulation element are arranged along a first guide axis.

Item 4. Headgear according to any of items 1-3, wherein the first stimulation element has an inner height larger than 2 mm.

Item 5. Headgear according to any of items 1-4, wherein the first stimulation element extends along a center axis from a first end to a second end pointing away from the inner surface, and wherein the first stimulation element has a width at the inner surface in the range from 4 mm to 20 mm.

Item 6. Headgear according to item 5, wherein the second end of the first stimulation element is a pointy end.

Item 7. Headgear according to any of items 1-6, the headgear comprising a fourth stimulation element in a fourth position on and protruding from the inner surface of the crown.

Item 8. Headgear according to item 7 as dependent on item 3, wherein the first stimulation element and the fourth stimulation element are arranged along a second guide axis, and wherein the first guide axis and the second guide axis form an angle larger than 30 degrees.

Item 9. Headgear according to any of items 1-8, the headgear comprising a fifth stimulation element in a fifth position on and protruding from the inner surface of the crown.

Item 10. Method for manufacturing a headgear, the method comprising:
providing a crown of a headgear, the crown having an inner surface;
mounting a first stimulation element in a first position on and protruding from the inner surface of the crown; and
mounting a second stimulation element in a second position on and protruding from the inner surface of the crown.

The use of the terms “first”, “second”, “third”, “fourth”, “fifth”, “primary”, “secondary”, “tertiary” etc. does not imply any particular order but are included to identify individual elements. Moreover, the use of the terms “first”, “second”, “third” and “fourth”, “fifth” “primary”, “secondary”, “tertiary” etc. does not denote any order or importance, but rather the terms “first”, “second”, “third” and “fourth”, “fifth”, “primary”, “secondary”, “tertiary” etc. are used to distinguish one element from another. Note that the words “first”, “second”, “third” and “fourth”, “fifth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### LIST OF REFERENCES

2 headgear

4 crown

6 brim

8 inner surface of the crown

10 first stimulation element

10A first position of first stimulation element

12 second stimulation element

12A second position of second stimulation element

14 third stimulation element

14A third position of third stimulation element

16 fourth stimulation element

16A fourth position of fourth stimulation element

18 fifth stimulation element

18A fifth position of fifth stimulation element

20 first guide line

22 second guide line

24 left marker

26 right marker

30, 30A, 30B stimulation part

32 locking part

34 first end

36 second end

38 inner height

40 width at inner surface of the crown

42 stimulation surface

43 contact surface

44 first portion

46 first spherical segment

48 first base

50 second portion

52 second spherical segment

53 intermediate portion

54 engagement portion of the stimulation part

56 outer portion

58 rod

60 outer portion

62 contact surface of the locking part

64 engagement portion of the stimulation part

X1 first guide axis

X2 second guide axis

XC center axis

1. A headgear comprising:
a crown with an inner surface;
a first stimulation element in a first position on and protruding from the inner surface of the crown, the first position being a center position of the crown; and
a second stimulation element in a second position on and protruding from the inner surface of the crown,
wherein the second stimulation element comprises a stimulation part and a locking part configured for locking engagement, and wherein a distance between the first stimulation element and the second stimulation element is in the range from 15 mm to about 40 mm.

2. Headgear according to claim 1, wherein an inner height of the first stimulation element is in the range from 2 mm to 6 mm.

3. Headgear according to claim 1, wherein the first stimulation element comprises a stimulation part and a locking part.

4. Headgear according to claim 3, wherein the stimulation part of the first stimulation element comprises a first portion comprising a first spherical segment.

5. Headgear according to claim 4, wherein the first spherical segment has a first radius and a first base, the first base forming a contact surface for facing and contacting the inner surface of the crown when the first stimulation element is mounted on the crown, and wherein the contact surface has a diameter in the range from 5 to 20 mm.

6. Headgear according to claim 4, wherein the stimulation part of the first stimulation element comprises a second portion comprising a second spherical segment.

7. Headgear according to claim 3, wherein the first stimulation element extends along a center axis, wherein the locking part of the first stimulation element comprises an engagement portion and an outer portion, wherein the outer portion of the locking part comprises a contact surface for facing and contacting the outer surface of the crown when the first stimulation element is mounted on the crown.

8. Headgear according to claim 1, wherein the second stimulation element extends along a center axis, wherein the locking part of the second stimulation element comprises an engagement portion and an outer portion.

9. Headgear according to claim 8, wherein the engagement portion of the locking part of the second stimulation element comprises a rod extending along the center axis and having a bulged outer surface with a tapered end.

10. Headgear according to claim 8, wherein the outer portion of the locking part of the second stimulation element comprises a contact surface for facing and contacting the outer surface of the crown when the second stimulation element is mounted on the crown.

11. Headgear according to claim 1, the headgear comprising a third stimulation element in a third position on and protruding from the inner surface of the crown, wherein the first stimulation element, the second stimulation element, and the third stimulation element are arranged along a first guide axis.

12. Headgear according to claim 1, wherein the first stimulation element has an inner height larger than 2 mm.

13. Headgear according to claim 1, wherein the first stimulation element extends along a center axis from a first end to a second end pointing away from the inner surface, and wherein the first stimulation element has a width at the inner surface in the range from 4 mm to 20 mm.

14. Headgear according to claim 13, wherein the second end of the first stimulation element is a pointy end.

15. Headgear according claim 11, the headgear comprising a fourth stimulation element in a fourth position on and protruding from the inner surface of the crown.

16. Headgear according to claim 15, wherein the first stimulation element and the fourth stimulation element are arranged along a second guide axis, and wherein the first guide axis and the second guide axis form an angle larger than 30 degrees.

17. Headgear according to claim 1, the headgear comprising a fifth stimulation element in a fifth position on and protruding from the inner surface of the crown.

18. Method for manufacturing a headgear, the method comprising:
providing a crown of a headgear, the crown having an inner surface;
mounting a first stimulation element in a first position on and protruding from the inner surface of the crown, the first position being a center position of the crown; and
mounting a second stimulation element in a second position on and protruding from the inner surface of the crown, wherein the second stimulation element comprises a stimulation part and a locking part configured for locking engagement, and wherein a distance between the first stimulation element and the second stimulation element is in the range from 15 mm to about 40 mm.
